(19) United States
(12) Patent Application Publication
(10) Pub. No.: US 2016/0096193 A1
(43) Pub. Date: Apr. 7, 2016

(54) PARYLENE DEPOSITION PROCESS

(71) Applicant: Applied Materials, Inc., Santa Clara, CA (US)

(72) Inventor: Kelvin CHAN, San Ramon, CA (US)

(21) Appl. No.: 14/505,553

(22) Filed: Oct. 3, 2014

(51) Int. Cl. B05D 1/00; B05C 9/12; B05C 9/14; B05B 1/18; B05C 9/10

(52) U.S. Cl. CPC B05D 1/60; B05B 1/185; B05C 9/10; B05C 9/14; B05C 9/12

(57) ABSTRACT

Embodiments of the disclosure generally related to methods of depositing parylene. The methods include introducing a first precursor into a processing chamber, and photolysing the first precursor into a second precursor using ultraviolet radiation. The second precursor is introduced into second and third regions of the processing chamber, separated by respective first and second showerheads. A substrate is exposed to the second precursor in the third region of the processing chamber to facilitate deposition of a parylene film on the substrate.

### BACKGROUND

1. Field

Embodiments of the present disclosure generally relate to a method of depositing parylene.

2. Description of the Related Art

Parylene films, and derivatives thereof, have been utilized for passivation and pore sealant on thin films and substrates, such as semiconductor substrates. Parylene may be deposited through vapor deposition techniques by absorption of p-xylylene on a substrate surface. The precursor p-xylylene is generated from the thermolysis of [2.2]paracyclophane. Thermolysis of [2.2]paracyclophane requires temperatures of about 600 degrees Celsius or more. Such high temperatures increase manufacturing costs due to energy consumption, and may also cause thermal budgeting concerns for processed substrates. Moreover, the high temperatures required for thermolysis demand that processing chambers be designed to withstand the elevated temperatures, thereby increasing manufacturing costs of the processing chambers.

Based on the foregoing, there is a need for an alternative method of depositing parylene films.

### SUMMARY

Embodiments of the disclosure generally related to methods of depositing parylene. The methods include introducing a first precursor into a processing chamber, and photolysing the first precursor into a second precursor using ultraviolet (UV) radiation. The second precursor is introduced into second and third regions of the processing chamber, separated by respective first and second showerheads. A substrate is exposed to the second precursor in the third region of the processing chamber to facilitate deposition of a parylene film on the substrate.

In one embodiment, a method of depositing parylene comprises introducing a first precursor into a first region of processing chamber; exposing the first precursor to ultraviolet radiation to cause photolysis of the first precursor into a second precursor; flowing the second precursor into a second region of the processing chamber, the second region separated from the first region by a first showerhead; flowing the second precursor into a third region of the processing chamber, the third region separated from the second region by a second showerhead; and exposing a substrate within the third region to the second precursor to form a parylene film on the substrate.

In another embodiment, a method of depositing parylene comprises introducing a first precursor into a first region of processing chamber, the first precursor selected from the group consisting of [2.2]paracyclophane, dichloro[2.2]paracyclophane, tetrachloro[2.2]paracyclophane, 4,12-dibromo[2.2]paracyclophane, and octafluoro[2.2]paracyclophane; exposing the first precursor to ultraviolet radiation to cause photolysis of the first precursor into a second precursor comprising p-xylylene; flowing the second precursor into a second region of the processing chamber, the second region separated from the first region by a first showerhead; flowing the second precursor into a third region of the processing chamber, the third region separated from the second region by a second showerhead; and exposing a substrate within the third region to the second precursor to form a parylene film on the substrate.

In another embodiment, a method of depositing parylene comprises introducing a first precursor into a first region of processing chamber, the first precursor selected from the group consisting of [2.2]paracyclophane, dichloro[2.2]paracyclophane, tetrachloro[2.2]paracyclophane, 4,12-dibromo[2.2]paracyclophane, and octafluoro[2.2]paracyclophane, wherein a temperature within the first region of the processing chamber is about 200 degrees Celsius or less; exposing the first precursor to ultraviolet radiation to cause photolysis of the first precursor into a second precursor comprising p-xylylene; flowing the second precursor into a second region of the processing chamber, the second region separated from the first region by a first showerhead; flowing the second precursor into a third region of the processing chamber, the third region separated from the second region by a second showerhead; and exposing a substrate within the third region to the second precursor to form a parylene film on the substrate, wherein the substrate is maintained at a temperature less than about 100 degrees Celsius during the exposing.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and the disclosure may admit to other equally effective embodiments.

FIG. 1 illustrates a sectional view of a processing chamber, according to one embodiment.

FIG. 2 illustrates a flow diagram of a method of forming a parylene film, according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the disclosure generally related to methods of depositing parylene. The methods include introducing a first precursor into a processing chamber, and photolysing the first precursor into a second precursor using ultraviolet radiation. The second precursor is introduced into second and third regions of the processing chamber, separated by respective first and second showerheads. A substrate is exposed to the second precursor in the third region of the processing chamber to facilitate deposition of a parylene film on the substrate.

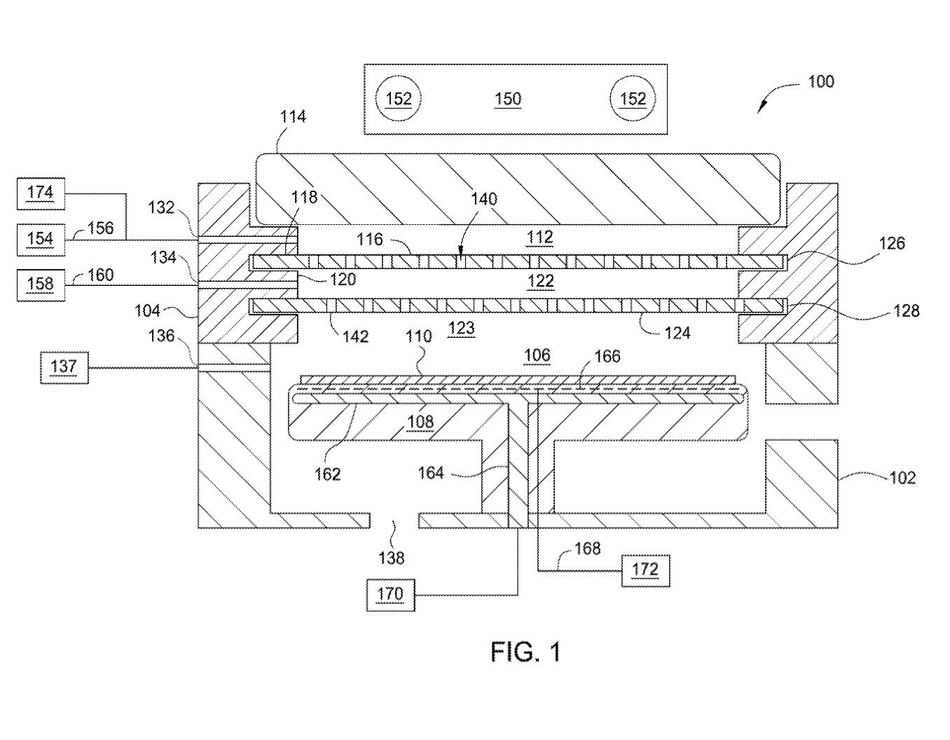

FIG. 1 illustrates a sectional view of a processing chamber 100, according to one embodiment. The processing chamber 100 may be the ONYX™ processing chamber available from Applied Materials, Inc., of Santa Clara, Calif. The processing chamber 100 may be used to practice methods described herein, however, other chambers, including those from other manufacturers, may also be used to practice embodiments of the disclosure.

The processing chamber 100 utilizes UV radiation to activate a precursor gas. The processing chamber 100 includes a chamber body 102 and a chamber lid 104 disposed over the chamber body 102. The chamber body 102 and the chamber lid 104 form an inner volume 106. A substrate support assembly 108 is disposed in the inner volume 106. The substrate support assembly 108 receives and supports a substrate 110 thereon for processing.

A first showerhead 116 is positioned in the inner volume 106 and supported by an upper clamping member 118 and a lower clamping member 120. A first region 112 is defined between an upper surface of the first showerhead 116 and a lower surface of a window 114 disposed above the first showerhead 116. The showerhead 116 is positioned to distribute one or more processing gases, such as precursor gases, across a second region 122 which is disposed below the first showerhead 216 and above a second showerhead 124. Each of the first and second showerheads 116 and 124 is disposed in a recess 126, 128, respectively, formed in the chamber lid 104. A first recess 126 is an annular recess around an internal surface of the chamber lid 104, and the first showerhead 116 fits into the first recess 126 to facilitate support for the first showerhead 116. Likewise, a second recess 128 receives the second showerhead 124 to facilitate support thereof.

The UV transparent window 114 is disposed above the first showerhead 116 and forms a fluid-tight seal with an upper surface of the chamber lid 104. The UV transparent window 114 may be secured to the chamber lid 114 by any convenient means, such as clamps, screws, or bolts. The UV transparent window 114 is at least partially transparent to thermal or radiant energy within the UV wavelengths, and optionally, with the IR wavelengths. The UV transparent window 214 may be quartz or another UV transparent silicon material, sapphire, CaF₂, MgF₂, AlON, a silicon oxide or silicon oxynitride material, or another transparent material.

The first showerhead 116 and the second showerhead 124 are each formed from a material which blocks or prevents a majority of UV radiation from passing therethrough, thus preventing the UV radiation from reaching the substrate 110. Optionally, the first showerhead 116 and the second showerhead 124 may also block radiation in the IR spectrum. In one example, first showerhead 116 and the second showerhead 124 may be formed from a ceramic material, such as aluminum oxide or aluminum nitride, or metals such as aluminum or stainless steel. It is contemplated that first showerhead 116 and the second showerhead 124 may be formed from a first material, such as aluminum, and then coated with a second material, such as a ceramic. Transmission of UV or IR radiation to the substrate 110 may be further reduced by offsetting or misaligning openings 140 formed in the first showerhead 116 with respect to openings 142 formed in the second showerhead 124.

The processing chamber 100 includes flow channels 132 and 134 configured to supply one or more processing gases to an internal volume of the processing chamber 100. A first flow channel 132 provides a flow pathway for gas to enter the region 112 and to be exposed to UV radiation from the UV source 150. Gas may be provided from a gas source 174, such as a canister, ampoule, gas box, and the like. After exposure to UV radiation, gas from the region 130 may flow through the openings 140 formed in the first showerhead 116 into the second region 122. An optional second flow channel 134 provides a flow pathway for gas to enter the second region 122 directly without passing through the first showerhead 116 to mix with the gas that was previously exposed to UV radiation in the first region 130. Gas within the second region 122 may then flow through openings 142 formed in the second showerhead 124 into a third region 123 proximate the substrate support 108. Once in the third region 123, the process gas can contact a surface of the substrate 110 to facilitate deposition of a material, such as parylene, on the substrate 110. Gases may be exhausted through an opening 136 coupled to a vacuum pump 137, and purge gases may be provided through the opening 138 in the bottom of the chamber, such that the purge gases flow around the substrate support 108, effectively preventing intrusion of process gases into the space under the substrate support 108.

A UV source 150 is disposed above the UV transparent window 114. The UV source 150 is configured to generate UV energy and project the UV energy towards the substrate support 108 through the UV transparent window 114 to facilitate photolysis (e.g., photo-facilitated cracking) of process gases within the first region 112. A cover (not shown) may be disposed above the UV source 150. In one embodiment, the cover may be shaped to assist projection of the UV energy from the UV source 150 towards the substrate support. In one example, the UV source 150 may also heat the first showerhead to reduce deposition of material thereon.

In one embodiment, the UV source 150 includes one or more UV lights 152 to generate UV radiation. The UV lights may be lamps, LED emitters, or other UV emitters. The UV lights 152 may be argon lamps discharging radiation at 126 nm, krypton lamps discharging at 146 nm, xenon lamps discharging at 172 nm, krypton chloride lamps discharging at 222 nm, xenon chloride lamps discharging at 308 nm, mercury lamps discharging at 254 nm or 365 nm, metal vapor lamps such as zinc, which discharges at 214 nm, rare earth near-UV lamps such as europium-doped strontium borate or fluoroborate lamps discharging at 368-371 nm. Other lamps and other emission spectrums are also contemplated.

A gas source 154, such as a purge gas, inert gas, precursor gas, or cleaning gas, may be coupled to the flow passage 132 through a conduit 156. A second gas source 158 may be coupled to the flow passage 134 through a conduit 160 to provide another process gas to the processing chamber 100. Optionally, the process gas source 158 may also be coupled to the flow passage 136. Appropriate valving may allow selection of one or both of the flow passages 134/136 for flowing the process gas into the processing chamber 100.

Substrate temperature may be controlled by providing heating and/or cooling features in the substrate support 108. A coolant conduit 164 may be coupled to a coolant source 170 to provide a coolant to a cooling plenum 162 disposed in the substrate support 108. One example of a coolant that may be used is a mixture of 50% ethylene glycol in water, by volume.

The coolant flow is controlled to maintain temperature of the substrate 110 at a desired level to promote deposition of UV-activated precursors on the substrate. A heating element 166 may also be provided in the substrate support 108. The heating element 166 may be a resistive heater, and may be coupled to a heating source 172, such as a power supply, by a conduit 168. The heating element 166 may be used to heat the substrate during a deposition process. In one example, during a deposition process, the substrate support 108 and the substrate 110 disposed thereon are maintained at a temperature less than about 100 degrees Celsius, such as about 23 degrees Celsius to about 100 degrees Celsius.

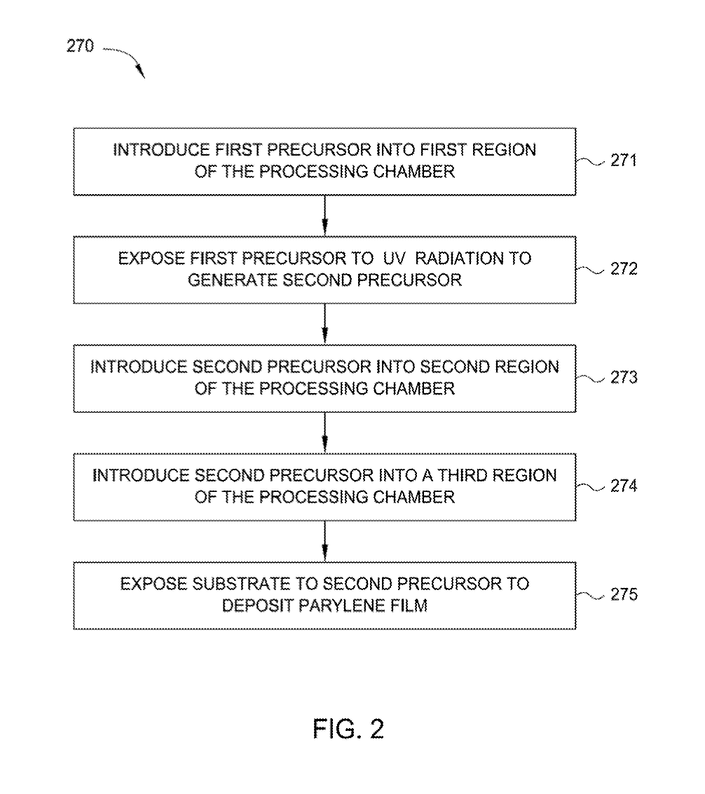

FIG. 2 illustrates a flow diagram of a method 270 of forming a parylene film, according to one embodiment. The method 270 begins at operation 271, in which a first precursor is introduced into a first region 112 of a processing chamber, such as the processing chamber 100 illustrated in FIG. 1. The first precursor may include one or more of [2.2]paracyclophane, dichloro[2.2]paracyclophane, or tetrachloro[2.2]paracyclophane, 4,12-dibromo[2.2]paracyclophane, or octafluoro[2.2]paracyclophane. In one example, the first precursor may be transferred from a heated canister or ampoule via a carrier gas, such as nitrogen, argon, or other gas which is inert with respect to processes occurring in the processing chamber. In one example, the concentration of the precursor relative to the carrier gas may be about 1 volume percent to about 100 volume percent. Other precursor delivery methods are also contemplated.

The first region 112 of the processing chamber 100 is positioned above the first showerhead 116 adjacent the transparent window 114 such that UV radiation may be delivered through the transparent window 114 to facilitate photolysing of the first precursor, in operation 272. During operation 272, the temperature within the first region 112 may be about 300 degrees Celsius or less, such as about 200 degrees Celsius or less. It is contemplated that greater absorption of UV light by the first showerhead 116 may result in a higher temperature within the first region 112. Photolysing of the first precursor dissociates the first precursor into a second precursor, such as p-xylylene or a p-xylylene halogen-substituted compound. In one example, the second precursor may be a monomer and the first precursor may be a dimer. During processing, the pressure within the process chamber 100 may be within a range of about 0.1 Torr to about 10 Torr to prevent recombination of the monomer into the dimer.

In operation 273, the second precursor is introduced into the second region 122 of the processing chamber 100 through openings 140 formed in a first showerhead 116. The second region 122 is separated from the first region 112 by the first showerhead 116. Subsequently, in operation 274, the second precursor is introduced into a third region 123 of the processing chamber 100 through openings 142 formed in a second showerhead 124. The third region 123 is separated from the second region 122 by the second showerhead 124. The first showerhead 116 and the second showerhead 124 prevent UV radiation from the UV source 150 from reaching the substrate 110 and degrading deposited films formed thereon. To further mitigate the amount of UV radiation reaching the substrate 110, the openings 140 formed within the first showerhead 116 are offset from the openings 142 formed within the second showerhead 124. The offset openings 140 and 142 reduce the transmission of UV radiation therethrough. A pressure differential may be created within the processing chamber 100 to facilitate movement of the first and second precursors through the first, second, and third regions of the processing chamber 100.

In operation 275, a substrate 110 is exposed to the second precursor within the third region 123 to deposit a parylene film on a surface of the substrate 110. In one example, the deposited film may have a thickness within a range of about 1 nanometer to about 1000 nanometers. During the deposition, the substrate support 108 and the substrate 110 thereon are maintained at a temperature less than about 100 degrees Celsius, such as about 23 degrees Celsius to about 100 degrees Celsius, to facilitate formation of the parylene film on the substrate 110 as the substrate 110 is contacted by the second precursor. Reaction by-products, unused precursor, and carrier/purge gases may then be exhausted from the chamber.

During method 270, particularly operation 273 of method 270, the first showerhead 116 is maintained at an elevated temperature, such as above 100 degrees Celsius, due to exposure to the UV radiation from the UV source 150. The elevated temperature of the first showerhead 116 prevents formation of a parylene film thereon. However, because the first showerhead 116 blocks a majority of the UV radiation emitted from the UV source 150, the second showerhead 124 may not be at a temperature above about 100 degrees Celsius, and thus, may be susceptible to parylene film deposition. To avoid sealing of the openings 142 due to parylene deposition, the openings 142 may be formed to a larger diameter than the openings 140 within the first showerhead 116. In one example, a majority or all of the openings 142 are larger than the openings 140. Alternatively, the second showerhead 124 may be positioned sufficiently close to the first showerhead 116 to allow for heating of the second showerhead 124 via radiation, thereby elevating the temperature of the second showerhead 124 to a temperature sufficient to prevent parylene deposition thereon.

Prior to operation 271 or subsequent to operation 275, an optional cleaning operation may be performed within the processing chamber 100. The cleaning operation may utilize an oxidizing gas, such as oxygen or ozone, to remove undesired material deposits from internal surface of the processing chamber 100. Alternatively, ionized NF₃ may be utilized to clean components of the chamber 100. UV exposure, plasma exposure, or thermal heating may be utilized to facilitate cleaning of deposits.

Embodiments of the present disclosure include less costly and lower thermal budget deposition of parylene films through reduced power consumption and lower temperature processing.

While the foregoing is directed to embodiments of the present disclosure, other and further embodiments of the disclosure may be devised without departing from the basic scope thereof, and the scope thereof is determined by the claims that follow.

What is claimed is:

1. A method of depositing parylene, comprising:
introducing a first precursor into a first region of processing chamber;
exposing the first precursor to ultraviolet radiation to cause photolysis of the first precursor into a second precursor;
flowing the second precursor into a second region of the processing chamber, the second region separated from the first region by a first showerhead;
flowing the second precursor into a third region of the processing chamber, the third region separated from the second region by a second showerhead; and
exposing a substrate within the third region to the second precursor to form a parylene film on the substrate.

2. The method of claim 1, wherein the first precursor is [2.2]paracyclophane.

3. The method of claim 1, wherein the second precursor is p-xylylene.

4. The method of claim 1, wherein a temperature within the first region of the processing chamber is about 300 degrees Celsius or less.

5. The method of claim 1, wherein the substrate is maintained at a temperature less than about 100 degrees Celsius during the exposing.

6. The method of claim 1, further comprising exposing the processing chamber to ozone gas during a cleaning processes.

7. The method of claim 1, wherein the first showerhead and the second showerhead are formed from a ceramic material, aluminum, or stainless steel.

8. The method of claim 7, wherein the first showerhead and the second showerhead comprise aluminum nitride or aluminum oxide.

9. The method of claim 1, wherein the first showerhead and the second showerhead each include a plurality of openings formed therein, and wherein a majority of the openings in the first showerhead are offset from a majority of the openings of the second showerhead.

10. The method of claim 9, wherein the openings in the second showerhead have a larger diameter than the openings in the first showerhead.

11. The method of claim 1, wherein the first precursor is dichloro[2.2]paracyclophane or tetrachloro[2.2]paracyclophane.

12. The method of claim 1, wherein the first precursor is 4,12-dibromo[2.2]paracyclophane.

13. The method of claim 1, wherein the first precursor is octafluoro[2.2]paracyclophane.

14. A method of depositing parylene, comprising:
introducing a first precursor into a first region of processing chamber, the first precursor selected from the group consisting of [2.2]paracyclophane, dichloro[2.2]paracyclophane, tetrachloro[2.2]paracyclophane, 4,12-dibromo[2.2]paracyclophane, and octafluoro[2.2]paracyclophane;
exposing the first precursor to ultraviolet radiation to cause photolysis of the first precursor into a second precursor comprising p-xylylene;
flowing the second precursor into a second region of the processing chamber, the second region separated from the first region by a first showerhead;
flowing the second precursor into a third region of the processing chamber, the third region separated from the second region by a second showerhead; and
exposing a substrate within the third region to the second precursor to form a parylene film on the substrate.

15. The method of claim 14, wherein the first showerhead and the second showerhead each include a plurality of openings formed therein, and wherein a majority of the openings in the first showerhead are offset from a majority of the openings of the second showerhead.

16. The method of claim 14, wherein the openings in the second showerhead have a larger diameter than the openings in the first showerhead, and wherein the parylene film deposited on the substrate is not exposed to ultraviolet radiation during the exposing the substrate within the third region to the second precursor.

17. The method of claim 16, wherein the substrate is maintained at a temperature less than about 100 degrees Celsius during the exposing.

18. The method of claim 17, wherein a temperature within the first region of the processing chamber is about 300 degrees Celsius or less.

19. A method of depositing parylene, comprising:
introducing a first precursor into a first region of processing chamber, the first precursor selected from the group consisting of [2.2]paracyclophane, dichloro[2.2]paracyclophane, tetrachloro[2.2]paracyclophane, 4,12-dibromo[2.2]paracyclophane, and octafluoro[2.2]paracyclophane, wherein a temperature within the first region of the processing chamber is about 200 degrees Celsius or less;
exposing the first precursor to ultraviolet radiation to cause photolysis of the first precursor into a second precursor comprising p-xylylene;
flowing the second precursor into a second region of the processing chamber, the second region separated from the first region by a first showerhead;
flowing the second precursor into a third region of the processing chamber, the third region separated from the second region by a second showerhead; and
exposing a substrate within the third region to the second precursor to form a parylene film on the substrate, wherein the substrate is maintained at a temperature less than about 100 degrees Celsius during the exposing.

20. The method of claim 19, wherein the first showerhead and the second showerhead are formed from a material that prevents the transmission of ultraviolet and infrared radiation therethrough.
